(19) United States
(12) Patent Application Publication
(10) Pub. No.: US 2014/0201106 A1
(43) Pub. Date: Jul. 17, 2014

(54) Method and System for Improving Performance of Endowments

(71) Applicants: Inworks Servicing, LLC, Portland, OR (US); CollegeNET, Inc., Portland, OR (US)

(72) Inventors: James H. Wolfston, JR., West Linn, OR (US); Jacques B. Nichols, Camas, WA (US); Donald G. Carlson, Hillsboro, OR (US); Rodney Schansman, Altanta, GA (US); James I. Walker, Newberg, OR (US); Melayne Yocum, Palos Verdes, CA (US)

(73) Assignees: Inworks Servicing, LLC, Portland, OR (US); CollegeNET, Inc., Portland, OR (US)

(21) Appl. No.: 14/156,840

(22) Filed: Jan. 16, 2014

Related U.S. Application Data
(63) Continuation of application No. 13/977,957.
(60) Provisional application No. 61/430,858, filed on Jan. 7, 2011.

(51) Int. Cl. G06Q 40/06

(52) U.S. Cl. CPC G06Q 40/06
USPC 705/36 R

(57) ABSTRACT

A method, system, and computer program product for providing a return on an investment to an endowment that also encourages donations by investing in a vehicles that provide a benefit to the endowed institution. The method includes receiving principal funds from one or more investing entities and receiving data describing an obligation of an endowed institution to pay for goods or services from a supplying entity. The method also includes making a payment to the supplying entity using at least a portion of the principal funds. The method also includes receiving a payment from the endowed institution at a later date for a greater amount than the earlier payment. The payment received from the endowed institution is made at a date later than the payment made to the supplying entity and is an amount that exceeds the payment made to the supplying entity. The method also includes making a payment to an endowment.

This Application is a Continuation Application of U.S. application Ser. No. 13/977,957, filed Jul. 2, 2013, which claims priority from and is the National Phase Entry of PCT/US2012/020661, filed Jan. 9, 2012, which claims priority from U.S. Provisional Appl. No. 61/430,858, filed Jan. 7, 2011, all of which are hereby incorporated by reference.

### TECHNICAL FIELD

The present invention relates to field of endowments, such as those that provide funding for universities, hospitals, and other institutions.

### BACKGROUND

Institutional endowments, such as the endowments affiliated with colleges, universities, hospitals, and other organizations, typically rely upon donations for endowment growth. Donations often comprise a greater proportion of the endowment than does the return on investments made with endowment funds. Managers of institutional endowments who rely on donations for growth need to seek out ways to maximize donations as well as optimize returns from the investment of endowment funds. The market implosion of 2008 illustrated the unusual extent to which endowment management techniques had verged toward speculation. At no time in history until 2008-2009, had university endowments suffered double digit losses across the board. By contrast, during the Great Depression of 1929-1932 Harvard's endowment grew.

A great portion of the losses during 2008-09 derived from investments made in what is known as the “shadow banking system” which includes unregulated hedge funds. Such funds often seek to juice returns by borrowing heavily in order to magnify the effect of underlying price moves. Further, managers of such funds insist on opacity, claiming the need to protect proprietary trading techniques. Owing to leverage, however, bets that go sour can lead to faster destruction of equity. By growing their investment commitment to the shadow banking system through 2008, universities unwittingly helped fuel the excesses that ultimately triggered widespread unemployment and distress.

Pursuing speculative returns for self-aggrandizement without careful regard to the uses for which the money is deployed not only risks high investment losses, it risks undercutting the willingness of benefactors to contribute. For such behavior belies the public service mission for which universities, hospitals, and other non-profits were chartered. Paying little heed to the purposes for which funds are ultimately used leads to the negative impression that an institution is motivated for its own greed, not the public interest. With respect to the debacle of 2008/09, potential donors can reasonably reflect: should university endowment money have been funneled into an unregulated shadow banking system that, in the end, led to global recession and high domestic unemployment?

Institutions supported by endowments typically draw down a portion of the endowment each year to support operations of the institution. But draw-downs of endowment funds available to the institution for operating expenses are usually limited to a fixed percentage. In the case of a university, when the endowment fails to experience sufficient growth or suffers losses, the ability to sustain drawdowns is reduced. During periods of economic recession the problem is compounded given that donations are typically reduced as the economy as a whole contracts. The university must then look to other sources of funding, such as increasing tuition. However, tuition increases during periods of economic contraction are limited by what students and their families are able to pay because they are likewise affected by the conditions of the economy at large. The university may then need to look at borrowing the money to make up the difference, for example, by issuing bonds. It is therefore important for an institution to maintain a high bond rating, to act in ways that uphold a public service mission, to encourage contributions, to protect returns, and to keep the cost of borrowing at a minimum, even during periods of economic recession.

### SUMMARY

Embodiments of the present invention provide a methods, systems, and computer program products for providing steady and improved performance of an endowment by increasing the probability that the act of endowment management itself enhances the propensity of donors to contribute. Endowment managers are often myopically guided in their deployment of funds by the rate of return and the purported safety of the investment. Other than by drawdowns, endowments typically do not invest principal directly in their beneficiary institution or in the individuals or the activities of individuals within the institution's community or other similar institutions and their communities. However, investing principal in the beneficiary institution or its community would likely encourage donations because donors could perceive direct benefit to the beneficiary institution and the institution's community from the deployment of their donated funds. In one embodiment, an endowment, directly or indirectly, loans money to another institution to permit that institution to more rapidly pay its bills and thereby generate early payment discounts. These discounts can be split between the bill paying institution and others such as a service provider, while also providing a return to the endowment providing the loan. This provides economic benefit to both the bill paying institution and the institution whose endowment funds are so applied.

The foregoing has outlined rather broadly features and technical advantages in order that the detailed description of the embodiments that follows may be better understood. Additional features and advantages will be described hereinafter. It should be appreciated by those skilled in the art that the conception and specific embodiments disclosed may be readily utilized as a basis for modifying or designing other structures for carrying out the same purposes. It should also be realized by those skilled in the art that such equivalent constructions do not depart from the spirit and scope of the invention as set forth in the appended claims.

### BRIEF DESCRIPTION OF THE DRAWINGS

Novel features characteristic of the invention are set forth in the appended claims. The embodiments, however, as well as a best mode of use, further purposes and advantages thereof, will best be understood by reference to the following detailed description of an illustrative embodiment when read in conjunction with the accompanying drawings, where:

FIG. 1 shows a block diagram depicting the relationships among the various entities in accordance with an embodiment of the present invention;

FIG. 2 shows a block diagram depicting the relationships among the various entities in accordance with an alternative embodiment of the present invention;

FIG. 3 shows a flowchart depicting a method for providing a return on an investment in accordance with an embodiment of the present invention; and

FIG. 4 shows a block diagram of computer system 400 suitable for storing and/or executing a computer program product in accordance with an embodiment of the present invention.

### DETAILED DESCRIPTION OF THE PREFERRED EMBODIMENTS

An institutional endowment can increase donations to the endowment by making investments with endowment funds that can be represented to potential donors as having an additional benefit to the donors' purposes beyond merely providing a return to the endowment. Especially in the case where endowment growth relies more on donations than on returns from investment, an investment of endowment funds that also increases donations to the endowment may provide a better effective return than other investment vehicles that focus on maximizing investment returns. Institutional endowment funds can be invested in accordance with an embodiment of the present invention to benefit the institution as well as provide a return on the investment to the endowment. For example, in the case of a university endowment, instead of simply investing endowment funds in stocks or bonds or investment vehicles brokered by disinterested investment banks, venture capitalists, or hedge fund managers, the endowment may experience greater overall growth, taking donations into consideration, by making targeted investments that are seen as a benefit to the greater university community by potential donors.

One embodiment of the present invention is a method that includes receiving principal funds directly or through a special fund from one or more investing endowments and receiving data that describe an obligation of an institution to pay for goods or services received from a supplying entity. The data include an amount payable and a due date. The method also includes making a payment to the supplying entity using at least a portion of the principal funds. The payment to the supplier is an amount less than the amount payable, is made on a date earlier than the due date, and is accepted by the supplying entity in satisfaction of the obligation of the institution. The method also includes receiving a payment from the institution at a date later than the payment made to the supplying entity and in an amount that exceeds the payment made to the supplying entity. The method also includes making a payment to the investing endowment(s). A portion of the payment to the investing endowment(s) includes an amount attributable to repayment of the principal funds plus a portion of the excess of the payment received from the institution over the payment made to the supplying entity.

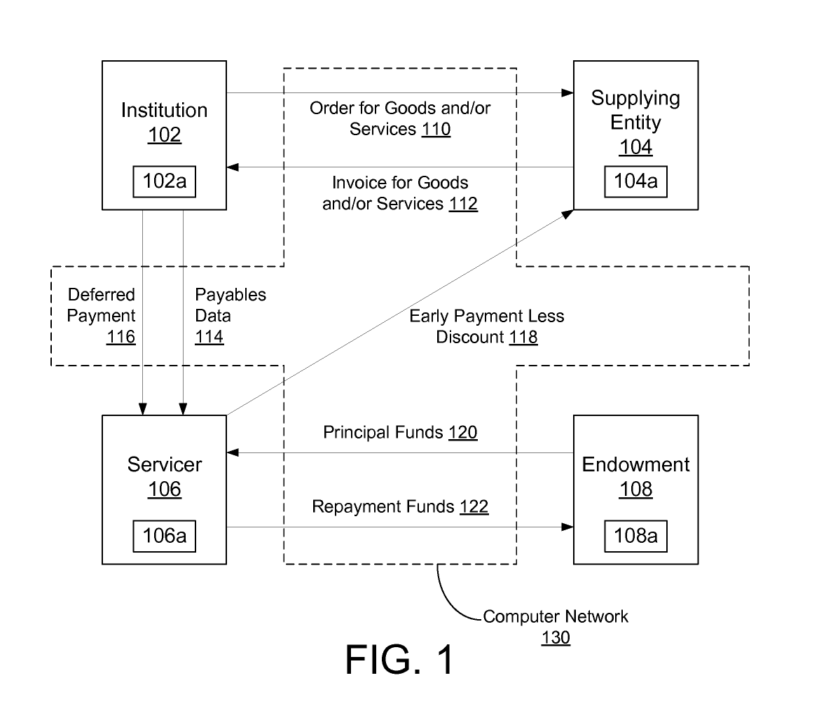

Turning now to FIG. 1, a block diagram is shown depicting the relationships among the various entities in accordance with an embodiment of the present invention. Institution 102 can be any business entity that regularly purchases products or services from supplying entity 104. Supplying entity 104 can be any business entity that sells goods or services such as a vendor. For example, institution 102 can be a university, and supplying entity 104 can be vendor of paper products. Institution 102 includes an institution computer 102A and supplying entity includes a supplying entity computer 104A. Institution 102 places an order 110 for products or services to be supplied by supplying entity 104. Supplying entity 104 delivers 112 the product and invoice to institution 102. Institution 102 may transmit order 110 to supplying entity 104 electronically over computer network 130 using institution computer 102A in communication with supplying entity computer 104A. Institution 102 may receive invoice 112 from supplying entity 104 electronically over computer network 130 using computer 102A in communication with computer 104A.

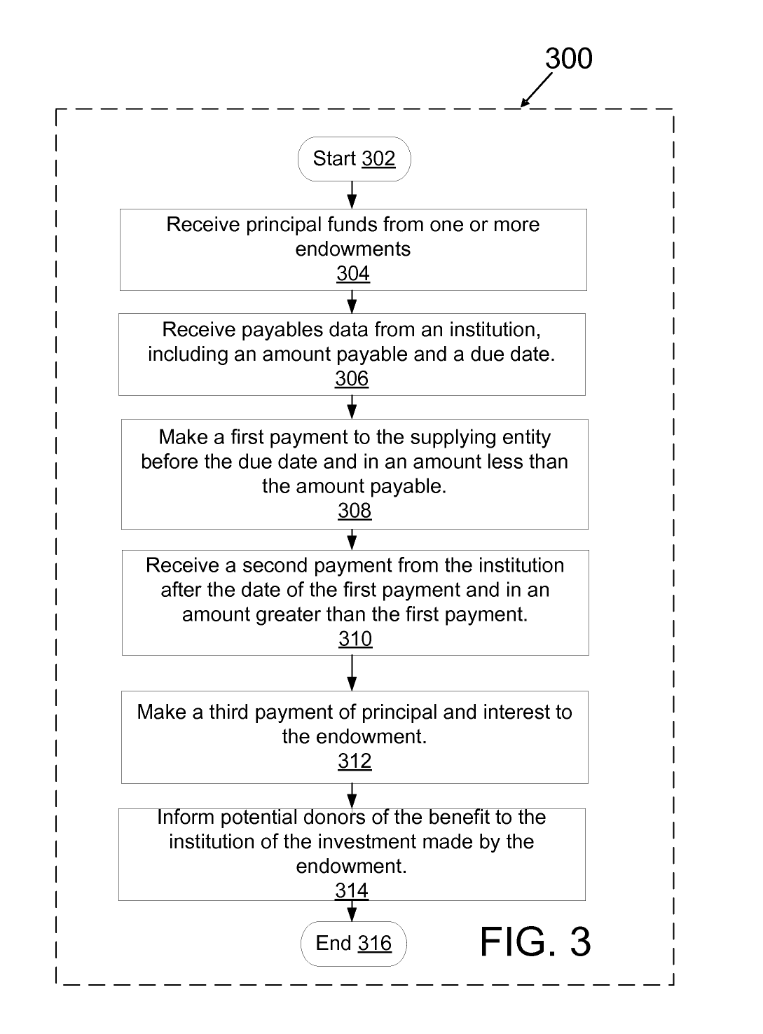

Institution 102 submits 114 payables data from the invoice to a servicer 106. Servicer 106, which includes a servicer computer 106A, may receive payables data 114 from institution 102 electronically over computer network 130 using servicer computer 106A in communication with institution computer 102A. Servicer 106 is a business entity set up for the purpose of implementing the method of FIG. 3, which is described in greater detail below. In one embodiment, institution 102 and servicer 106 enter into a direct contractual relationship whereby institution 102 guarantees the dollar amount and payment date of the payables, and servicer 106 makes payment to supplying entity 104 on behalf of institution 102. Servicer 106 may require institution 102 to meet certain credit requirements before entering into the contractual relationship. Payables data include an amount of money that institution 102 owes supplying entity 104 for the delivered goods or services and a due date when payment is due on the invoice. Continuing the university example, payables data may include an amount of $10,000 owed for paper products delivered to the university by the vendor, payment of which is due forty-five days from the date of delivery.

Servicer 106 and supplying entity 104 enter into a contractual relationship whereby supplying entity 104 agrees to discount a portion of the amount payable in exchange for servicer 106 paying the amount payable, less the discount, earlier than the date payment is due according to the invoice. For example, supplying entity 104 agrees to accept payment in the amount of 96% of invoiced amount payable as payment in full if the supplying entity 104 receives payment within five days of invoicing institution 102 instead of after sixty days. This arrangement is agreeable to many vendors because having invoices paid quickly, predictably, and with increased certainty is worth a reasonable discount. Servicer 106 then makes early payment 118 on the invoice to supplying entity 104, less the agreed upon discount. Payment 118 may be made by electronic computer transaction, such as an automated clearinghouse (ACH) transaction.

Institution 102 makes deferred payment 116 to servicer 106 by a date agreed upon in the contract. The date agreed upon in the contract is a date after early payment 118 is made by servicer to supplying entity 104. The amount of the payment may be equal to the amount payable on the invoice. Or servicer 106 may share a portion of the discount with institution 102 and accept a payment that is less than the amount payable on the invoice. For example, the paper vendor may agree to accept a payment of 96% of the amount payable on the invoice in exchange for payment within 5 days of invoicing. On April 1, the paper vendor delivers $10,000 of paper products to the university and the invoice for those products payable in 60 days. The university reconciles the delivery with the invoice and, barring any discrepancy, electronically submits the payables data from the invoice to servicer 206 on April 2. Servicer 106 pays the paper vendor $9600 by automated clearing house (ACH) transaction on April 3, within 5 days of invoicing. The university and servicer 106 have agreed that the university will pay servicer 106 an amount equal to 99% of the amount payable within the period specified by the invoice. On May 31, the university pays servicer 106 $9900. This procedure represents a benefit to the university for several reasons. One reason is that in this example the university saves 1% of the amount payable, in this case $100. Another reason this represents a benefit to the university is that early payments of accounts payable improves the bond rating of the university, making it less expensive for the university to borrow money. In fact, the improvement in the bond rating and in supplier relationships may be sufficient for the university to agree to pay 100% of the invoiced amount so that servicer 106 retains all of the vendor's discount.

Servicer 106 can raise the capital needed to make early payment 118 to supplying entity 104 by soliciting and receiving an investment of principal funds 120 from an endowment 108 in exchange for a promise to pay repayment funds 122 to endowment 108 at a later date. Repayment funds 122 include repayment of the principal funds received from endowment 108 and a return on the investment of endowment 108. For example, endowment 108 may be a university endowment. Servicer 106 sells bonds with a 10% coupon which are then purchased by the university endowments. Special purpose entity 106 makes a minimum return of 3% every 60 days based on the foregoing example, which represents an annual rate of return of 18%. If the bonds mature after one year, special purpose entity 106 pays back the principal to the university endowment along with a 10% interest payment and retains 8% in earnings. To the extent that the university itself or other universities are beneficiaries of the above service, the university can solicit donations to the endowment by informing potential donors that endowment funds are being invested in a manner that reduces the costs of the university operations while at the same time improving the university bond ratings. While the numbers in the above mentioned example may appear modest, one skilled in the art will appreciate how the numbers scale upward as the number of transactions and entities increases. Endowment 108 includes an endowment computer 108A. Each of the computers 102A, 104A, 106A, and 108A is connected, directly or indirectly to global computer network 130. All actions shown in FIG. 1, with the exception of delivery of a physical product from supplying entity 104 to institution 102, are preferably performed over the global computer network using computers 102a, 104a, 106a, and/or 108a and executing computer software embodied as computer-executable instructions encoded in and read from a tangible, computer-readable medium.

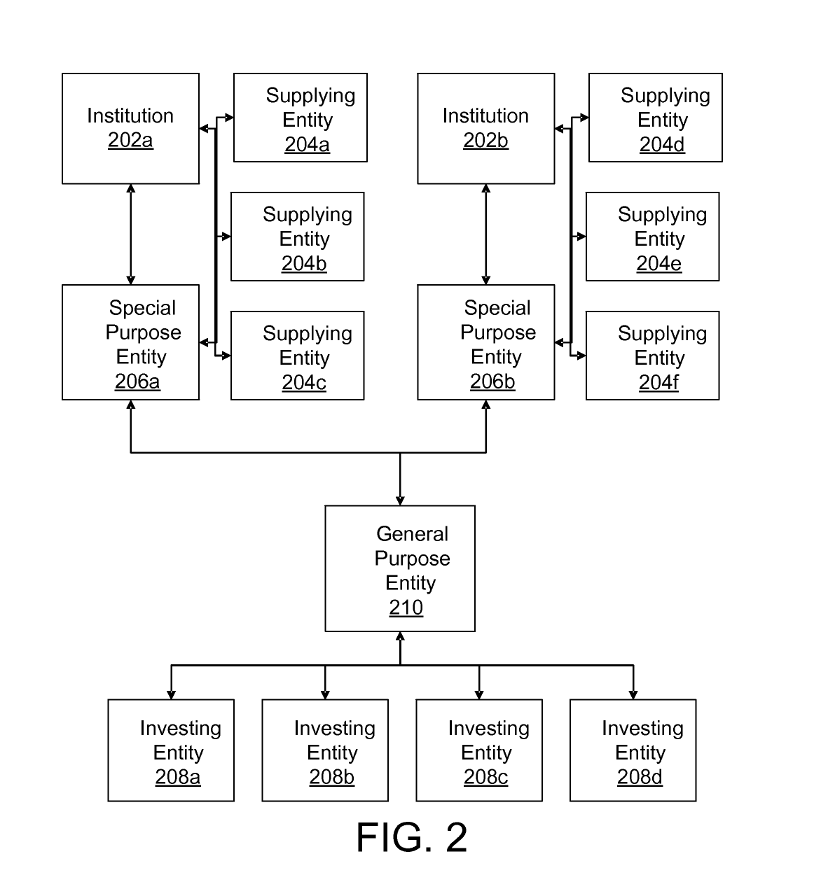

FIG. 1 is meant to depict an exemplary embodiment of the present invention. One skilled in the art will understand that servicer entity 106 may service many different purchasing entities and supplying entities and receive funds from many different investing entities. Alternatively, servicer 106 could be a part of or controlled by endowment 108. As servicer 106 develops ongoing relationships with supplying entities, servicer 106 can market the service it provides to other purchasing entities with similar supplier needs. Alternatively, as shown in FIG. 2, for large institutions 202a-b with many supplying entities 204a-f, special purpose entities 206a-b may be set up as investment vehicles so that each large institution has a corresponding special purpose entity, which function like servicer 106 of FIG. 1. For example, special purpose entity 206a is set up to service payments for institution 202a to supplying entities 204a-c, special purpose entity 206b is set up to service payments for institution 202b to supplying entities 204d-f, and so on. Investing entities 208a-d may make investments to each special purpose entity or alternatively, as shown in FIG. 2, may make investments to a general purpose entity 210 that in turn manages the flow of invested funds to and from the special purpose entities 206a-b. The special purpose entities 206a-b and general purpose entity 210 can be structured so that assets of general purpose entity 210 are protected in the event of a bankruptcy of a special purpose entity 206. In one embodiment, investing entities 208a-d comprise endowments, such as endowment 108.

Turning now to FIG. 3, a flowchart 300 is shown depicting a method for providing a return on an investment in accordance with an embodiment of the present invention. The method begins at start block 302. Servicer 106 receives principal funds as an investment from one or more investing entities, such as endowment 108 (step 304). The funds are typically received as electronic transfers over computer network 130, originating from software executing on computer 106A. Servicer 106 receives payables data, typically transmitted over a global computer network, describing an obligation of institution 102 to pay for goods or services received by institution 102 from supplying entity 104 (step 306). The payables data include an amount payable and a due date (step 306). The payables data may originate from an invoice provided to institution 102 by supplying entity 104 upon delivery of the goods or performance of the services. Payables data 114 originates from software executing on institution computer 102A and is transmitted over computer network 130 to servicer computer 106A. The payables data would preferably be provided to servicer 106 by institution 102 as soon after reconciling the delivery with the invoice as possible. But the data may alternatively be provided to servicer 106 by supplying entity 104 directly, preferably transmitted over computer network 130 from computer 104a to computer 106a.

After servicer 106 receives the payables data in step 306, servicer 106 makes a payment to supplying entity 104 (step 308). The payment is made before the due date and in an amount that is less than the amount payable. All fund transfers in the steps of FIG. 3 and FIG. 1 are preferably originated from a computer at the transferor, which causes funds to be transferred from a bank account of the transferor to a bank account of the party receiving the funds, preferably with an electronic notification of the transfer preferably being supplied to the entity receiving the funds. Preferably, the time and amount of the payment in step 308 is agreed upon by servicer 106 and supplying entity 104 in advance. The agreement may be set forth in a contract between servicer 106 and supplying entity 104.

After servicer 106 makes the payment of step 308 to supplying entity 104, servicer 106 receives a payment from institution 102 (step 310). The amount of the payment received by servicer 106 in step 310 is greater than the amount of the payment made by servicer 106 in step 308. Preferably, the time and amount of the payment in step 310 is agreed upon by servicer 106 and institution 102 in advance. The agreement may be set forth in a contract between servicer 106 and institution 102.

After servicer 106 receives the payment of step 310 from institution 102, servicer 106 makes a payment to endowment 108 (step 312). The payment made to endowment 108 includes all or a portion of the principal funds received from the endowment and at least a portion of the excess of the amount received by servicer 106 in step 310 from institution 102 over the amount paid by servicer 106 in step 308 to supplying entity 104. The portion of the excess paid to endowment 108 represents the return on the investment made by endowment in step 304. The funds received in step 304 may be the result of a sale of bonds by servicer 106. The payment made in step 312 may be the result of a maturation of bonds sold in step 304. Persons of skill in the art will appreciate that the methods utilized by the servicer for obtaining liquidity are not limited to the selling of bonds.

At step 314, potential donors to endowment 108 are informed of the benefit to institution 102 of the investment of principal funds 120 made by endowment 108. Potential donors may be more willing to donate, or may make a larger donation to endowment 108 if the potential donors know that donations to endowment 108 benefit institution 102 by use of the method of FIG. 3. Potential donors may be informed of the benefits by posting the information on a web site, by direct mailing, or during individual telephone or in-person solicitations.

In at least one embodiment of the present invention, endowment 108 is an institutional endowment, such as a college or university endowment. In another embodiment of the present invention, institution 102 is a college or a university. In yet another embodiment of the present invention, endowment 108 is the endowment of a college or university that is institution 102. In this embodiment, investments made by the university endowment in accordance with the present invention can reduce the operating expenses of the university and/or improve the bond rating of the university by retiring accounts payable earlier. The university endowment, in turn, can solicit donations from potential donors based on the fact that investments made with funds donated to the endowment directly benefit the university. For a university endowment that relies heavily on donations for growth, investments that increase donations as well as provide a competitive rate of return are preferable to investments that merely provide a competitive rate of return.

One or more of the steps of FIG. 3 or FIG. 1 can be performed automatically, by which is meant without human intervention, whether or not initiated by the action of a person or event. It will also be understood that the steps of FIG. 3 or FIG. 1 can be considered from the point of view of any of the actors. For example, the submission of payables data 114 to servicer 106, can be considered as servicer 106 receiving payables data from institution 102.

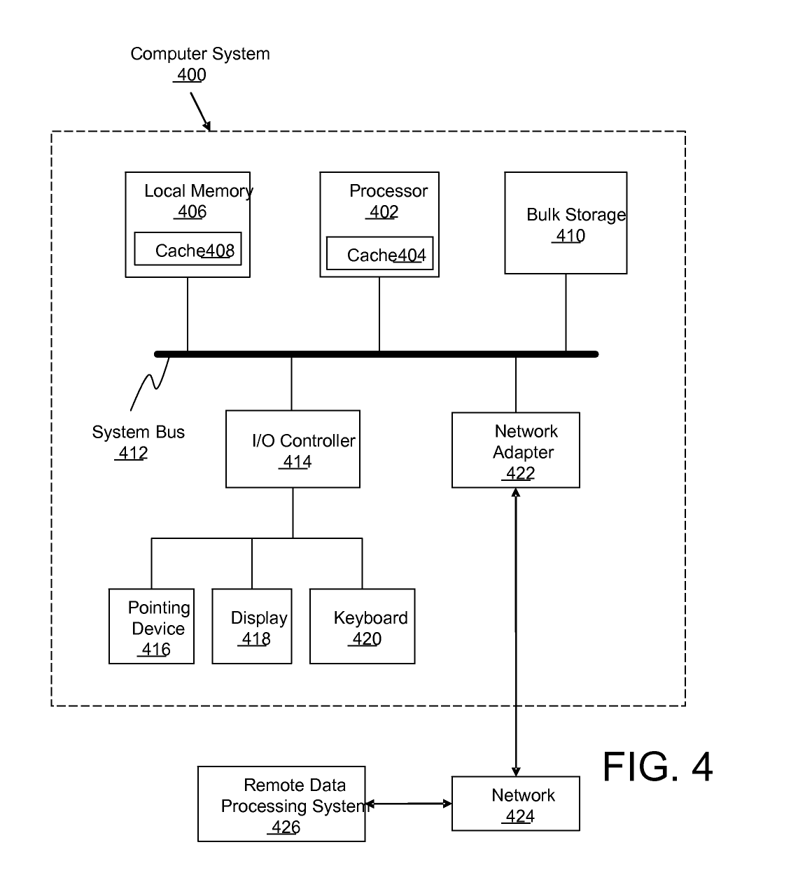

One embodiment of the present invention is a computer program product encoded in a tangible, computer-readable medium. The computer program product comprises computer-executable instructions that, when executed, causes one or more computer systems to perform the method of FIG. 3. Turning now to FIG. 4, a block diagram is shown of computer system 400 suitable for storing and/or executing a computer program product in accordance with an embodiment of the present invention. Computer systems 102A, 104A, 160A, and 108A, all of FIG. 1, can comprise a computer system, such as computer system 400. Data processing system 400 includes at least one processor 402 coupled directly or indirectly to memory elements through system bus 412. The memory elements comprise a tangible computer-readable medium and can include local memory 406 employed during the actual execution of the program code, bulk storage 410, and cache memories 404 and 408 which provide temporary storage of at least some program code in order to reduce the number of times code must be retrieved from bulk storage 410 during execution. Input/output or I/O devices (including but not limited to keyboards 420, displays 418, pointing devices 416, etc.) can be coupled to the system either directly or through intervening I/O controllers 414. Network adapters 422 may also be coupled to data processing system 400 to enable the system to become coupled to remote computer system 426 or remote printers or storage devices through intervening private or public networks 424. Modems, cable modems, Ethernet cards, and wireless network adapters are just a few of the currently available types of network adapters.

Preferred embodiments of the present invention thus provide a method for encouraging donations to an institutional endowment, the method comprising receiving data describing an obligation of an institution to pay for goods and/or services, the goods and/or services received by the institution from a supplying entity, in which the data include an amount payable and a due date; making a first payment to the supplying entity using at least a portion of principal funds received from an endowment the first payment is an amount less than the amount payable, in which the first payment is made on a date earlier than the due date, and in which the supplying entity accepts the first payment in satisfaction of the obligation of the institution; receiving a second payment from the institution, in which the second payment is made at a date later than the first payment, and in which the second payment is an amount that exceeds the first payment; making a third payment to an endowment, in which a portion of the third payment includes an amount attributable to repayment of the principal funds, and in which a portion of the third payment includes an amount attributable to the excess of the second payment over the first payment; and the process proving a benefit to the institution to encourage donation to the endowment.

According to preferred embodiments, the method includes informing potential endowment donors of the benefit to the institution provided by the principal funds invested by the endowment. Preferably, the second payment is an amount less than the amount payable. According to some preferred embodiments, the institution is an educational institution. According to some preferred embodiments, the endowment is an endowment of an education institution. According to some preferred embodiments, the educational institution is a university. According to some preferred embodiments, the endowment from which at least a portion of the principal funds are received is an endowment of the institution.

Preferred embodiments of the present invention also provide a system for encouraging donations to an institutional endowment, the system comprising at least one processor; at least one computer-readable medium communicatively coupled to the processor by an electrical bus; at least one network interface communicatively coupled to the processor by the electrical bus, the network interface coupled to a communications network, the computer-readable medium encoded with computer instructions operable to cause the processor to receive supplier data from the communications network, the supplier data describing an obligation of an institution to pay for goods or services received by the institution from a supplying entity, wherein the supplier data include an amount payable and a due date; transmit first payment data to the communications network, the first payment data causing a first payment to be made to the supplying entity using at least a portion of principal funds received from an endowment, in which the first payment is an amount less than the amount payable, in which the first payment is made on a date earlier than the due date, and in which the supplying entity accepts the first payment in satisfaction of the obligation of the institution; receive second payment data from the communications network, the second payment data indicating that a second payment has been received from the institution, in which the second payment is made at a date later than the first payment, and in which the second payment is an amount that exceeds the first payment; transmit third payment data to the communications network, the third payment data causing a third payment to be made to the endowment, in which a portion of the third payment includes an amount attributable to repayment of the principal funds, and in which a portion of the third payment includes an amount attributable to excess of the second payment over the first payment. According to preferred embodiments, the payment data are automated clearing house (ACH) transactions.

Preferred embodiments of the present invention also provide a tangible, computer-readable medium encoded with a computer program product for encouraging donations to an institutional endowment, the computer program product comprising instructions that, when executed by a computer processor communicatively coupled to a communications network, cause the computer processor to receive supplier data from the communications network, the supplier data describing an obligation of an institution to pay for goods or services received by the institution from a supplying entity, wherein the supplier data include an amount payable and a due date; transmit first payment data to the communications network, the first payment data causing a first payment to be made to the supplying entity using at least a portion of principal funds received from an endowment, in which the first payment is an amount less than the amount payable, in which the first payment is made on a date earlier than the due date, and in which the supplying entity accepts the first payment in satisfaction of the obligation of the institution; receive second payment data from the communications network, the second payment data indicating that a second payment has been received from the institution, in which the second payment is made at a date later than the first payment, and in which the second payment is an amount that exceeds the first payment; transmit third payment data to the communications network, the third payment data causing a third payment to be made to the endowment, in which a portion of the third payment includes an amount attributable to repayment of the principal funds, and in which a portion of the third payment includes an amount attributable to excess of the second payment over the first payment. According to preferred embodiments, the payment data are automated clearing house (ACH) transactions.

It will be understood that the invention includes more than one novel aspect. Different embodiments can be constructed for different purposes using any of, or combination of, the different aspects of the invention, and not all the advantages of the invention are, therefore, necessarily achieved by every embodiment that is within the scope of the attached claims.

Further, it should be recognized that embodiments of the present invention can be implemented via computer hardware, a combination of both hardware and software, or by computer instructions stored in a non-transitory computer-readable memory. The methods can be implemented in computer programs using standard programming techniques—including a non-transitory computer-readable storage medium configured with a computer program, where the storage medium so configured causes a computer to operate in a specific and predefined manner—according to the methods and figures described in this Specification. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits programmed for that purpose.

Computer programs can be applied to input data to perform the functions described herein and thereby transform the input data to generate output data. The output information is applied to one or more output devices such as a display monitor. In preferred embodiments of the present invention, the transformed data represents physical and tangible objects, including producing a particular visual depiction of the physical and tangible objects on a display.

Throughout the present specification, discussions utilizing terms such as “calculating,” “determining,” “generating,” “receiving,” “transmitting”, or the like, refer to the action and processes of a computer system, or similar electronic device, that manipulates and transforms data represented as physical quantities within the computer system into other data similarly represented as physical quantities within the computer system or other information storage, transmission or display devices.

Although various embodiments and their s advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A method for encouraging donations to an institutional endowment comprising:
receiving data describing an obligation of an institution to pay for goods and/or services, the goods and/or services received by the institution from a supplying entity, wherein the data include an amount payable and a due date;
making a first payment to the supplying entity using at least a portion of principal funds received from an endowment,
wherein the first payment is an amount less than the amount payable,
wherein the first payment is made on a date earlier than the due date, and
wherein the supplying entity accepts the first payment in satisfaction of the obligation of the institution;
receiving a second payment from the institution,
wherein the second payment is made at a date later than the first payment, and
wherein the second payment is an amount that exceeds the first payment;
making a third payment to an endowment,
wherein a portion of the third payment includes an amount attributable to repayment of the principal funds, and
wherein a portion of the third payment includes an amount attributable to the excess of the second payment over the first payment; and
the process proving a benefit to the institution to encourage donation to the endowment.

2. The method of claim 1, further comprising informing potential endowment donors of the benefit to the institution provided by the principal funds invested by the endowment.

3. The method of claim 1, wherein the second payment is an amount less than the amount payable.

4. The method of claim 1, wherein the endowment is an endowment of an educational institution.

5. The method of claim 1, wherein the institution is an educational institution.

6. The method of claim 1, wherein the endowment from which at least a portion of the principal funds are received is an endowment of the institution.

7. The method of claim 4, wherein the educational institution is a university.

8. The method of claim 5, wherein the educational institution is a university.

9. A system for encouraging donations to an institutional endowment comprising:
at least one processor;
at least one computer-readable medium communicatively coupled to the processor by an electrical bus;
at least one network interface communicatively coupled to the processor by the electrical bus, the network interface coupled to a communications network;
the computer-readable medium encoded with computer instructions operable to cause the processor to:
receive supplier data from the communications network, the supplier data describing an obligation of an institution to pay for goods or services received by the institution from a supplying entity, wherein the supplier data include an amount payable and a due date;
transmit first payment data to the communications network, the first payment data causing a first payment to be made to the supplying entity using at least a portion of principal funds received from an endowment,
wherein the first payment is an amount less than the amount payable,
wherein the first payment is made on a date earlier than the due date, and
wherein the supplying entity accepts the first payment in satisfaction of the obligation of the institution;
receive second payment data from the communications network, the second payment data indicating that a second payment has been received from the institution,
wherein the second payment is made at a date later than the first payment, and
wherein the second payment is an amount that exceeds the first payment;
transmit third payment data to the communications network, the third payment data causing a third payment to be made to the endowment,
wherein a portion of the third payment includes an amount attributable to repayment of the principal funds, and
wherein a portion of the third payment includes an amount attributable to excess of the second payment over the first payment.

10. The system of claim 8, wherein the payment data are automated clearing house transactions.

11. The system of claim 8, wherein the second payment is an amount less than the amount payable.

12. The system of claim 8, wherein the endowment is an endowment of an educational institution.

13. The system of claim 8, wherein the institution is an educational institution.

14. The system of claim 8, wherein the endowment from which at least a portion of the principal funds are received is an endowment of the institution.

15. The system of claim 12, wherein the educational institution is a university.

16. The system of claim 13, wherein the educational institution is a university.

17. A tangible, computer-readable medium encoded with a computer program product for encouraging donations to an institutional endowment, the computer program product comprising instructions that, when executed by a computer processor communicatively coupled to a communications network, cause the computer processor to:
receive supplier data from the communications network, the supplier data describing an obligation of an institution to pay for goods or services received by the institution from a supplying entity, wherein the supplier data include an amount payable and a due date;
transmit first payment data to the communications network, the first payment data causing a first payment to be made to the supplying entity using at least a portion of principal funds received from an endowment,
wherein the first payment is an amount less than the amount payable,
wherein the first payment is made on a date earlier than the due date, and
wherein the supplying entity accepts the first payment in satisfaction of the obligation of the institution;
receive second payment data from the communications network, the second payment data indicating that a second payment has been received from the institution,
wherein the second payment is made at a date later than the first payment, and
wherein the second payment is an amount that exceeds the first payment;
transmit third payment data to the communications network, the third payment data causing a third payment to be made to the endowment,
wherein a portion of the third payment includes an amount attributable to repayment of the principal funds, and
wherein a portion of the third payment includes an amount attributable to excess of the second payment over the first payment.

18. The computer-readable medium of claim 16, wherein the payment data are automated clearing house transactions.

19. The computer-readable medium of claim 16, wherein the second payment is an amount less than the amount payable.

20. The computer-readable medium of claim 16, wherein the endowment is an endowment of an educational institution.

21. The computer-readable medium of claim 16, wherein the institution is an educational institution.

22. The computer-readable medium of claim 16, wherein the endowment from which at least a portion of the principal funds are received is an endowment of the institution.

23. The computer-readable medium of claim 20, wherein the educational institution is a university

24. The computer-readable medium of claim 21, wherein the educational institution is a university
